(19) United States
(12) Patent Application Publication
(10) Pub. No.: US 2026/0023152 A1
(43) Pub. Date: Jan. 22, 2026

(54) RADAR DEVICE

(71) Applicant: HL KLEMOVE CORPORATION, Incheon (KR)

(72) Inventor: Yunsu KANG, Incheon (KR)

(73) Assignee: HL KLEMOVE CORPORATION, Incheon (KR)

(21) Appl. No.: 19/232,412

(22) Filed: Jun. 9, 2025

(30) Foreign Application Priority Data
Jul. 22, 2024 (KR) 10-2024-0096259

(51) Int. Cl. G01S 7/02; G01S 13/931; H01Q 1/32; H01Q 17/00

(52) U.S. Cl. CPC G01S 7/027; G01S 13/931; H01Q 1/3233; H01Q 17/002; H01Q 17/008

(57) ABSTRACT

A radar device is disclosed. The radar device may include a circuit board on which a circuit element that generates or receives electromagnetic waves is placed; a waveguide antenna stacked on one surface of the circuit board, and in which a port through which the electromagnetic waves pass is through-formed; and a plurality of pins spaced apart from each other, in the form of surrounding an opening of the port, on one surface of the waveguide antenna facing the circuit board, and having a pillar shape.

### CROSS-REFERENCE TO RELATED APPLICATION

This application claims priority to and benefit from Korean Patent Application No. 10-2024-0096259, filed on Jul. 22, 2024, the disclosure of which is incorporated herein by reference in its entirety.

### TECHNICAL FIELD

The present disclosure relates to a radar device, and more particularly, to a radar device that detects an object by transmitting electromagnetic waves and receiving electromagnetic waves reflected back from the object.

### DESCRIPTION OF RELATED ART

A radar radiates electromagnetic waves from the antenna and receives electromagnetic waves that are reflected back from the target. A vehicle radar mounted on a vehicle to detect a target on the road uses electromagnetic waves with a wavelength in the millimeter band. For example, the vehicle radar may use electromagnetic waves with a wavelength of about 4 mm and a frequency of 77 GHz.

The wavelength of electromagnetic waves used in vehicle radars is physically small. The smaller the wavelength of the electromagnetic wave and the higher the frequency used, the more sensitive the radar's performance becomes to the minute errors that occur during the antenna manufacturing process.

The antenna of a vehicle radar includes multiple layers of feeding lines and a radiator that radiates electromagnetic waves, and forms a laminated structure in which multiple layers are bonded to each other. During the formation process of these multilayer bonding structures, minute gaps may occur between layers, which may cause leakage or reflection of electromagnetic waves. This may reduce the radar detection range and increase the probability of false detection.

### BRIEF SUMMARY

The present disclosure is to solve the above problems, and the present disclosure is directed to providing a radar device that suppresses the occurrence of leakage in a process of transmitting electromagnetic waves.

The present disclosure is also directed to providing a radar device that exhibits robustness against fine gaps between layers or axial alignment defects of waveguide lines of electromagnetic waves having a form in which a plurality of layers are bonded.

The objects of the present disclosure are not limited to the above-described objects, and other objects that are not mentioned will be able to be clearly understood by those skilled in the art to which the present disclosure pertains from the following description.

According to an aspect of the present disclosure, provided is a radar device, including a circuit board on which a circuit element that generates or receives electromagnetic waves is placed; a waveguide antenna stacked on one surface of the circuit board, and in which a port through which the electromagnetic waves pass is through-formed; and a plurality of pins spaced apart from each other, in the form of surrounding an opening of the port, on one surface of the waveguide antenna facing the circuit board, and having a pillar shape.

In the radar device according to an aspect of the present disclosure, each of the plurality of pins may have a polygonal pillar shape.

In the radar device according to an aspect of the present disclosure, each of the plurality of pins may have a hexagonal pillar shape.

In the radar device according to an aspect of the present disclosure, each of the plurality of pins may be arranged such that a normal line of an opposite side facing the opening is perpendicular to an edge of the opening or a tangent line of the edge of the opening.

In the radar device according to an aspect of the present disclosure, a distance between the plurality of pins may be formed to be constant.

In the radar device according to an aspect of the present disclosure, some of the plurality of pins may have a first diameter, and another some of the plurality of pins may have a second diameter smaller than the first diameter.

In the radar device according to an aspect of the present disclosure, some of the plurality of pins may be placed in a first area within a first distance from an edge of the opening of the port, and another some of the plurality of pins may be placed in a second area that is farther than the first distance and within a second distance from the edge of the opening of the port (the second distance is greater than the first distance).

In the radar device according to an aspect of the present disclosure, among the plurality of pins, those disposed in the first area may have a first diameter, and among the plurality of pins, those disposed in the second area may have a second diameter smaller than the first diameter.

In the radar device according to an aspect of the present disclosure, yet another some of the plurality of pins may be placed in a third area that is farther than the second distance and within a third distance from the edge of the opening of the port (the third distance is greater than the second distance).

In the radar device according to an aspect of the present disclosure, among the plurality of pins, those disposed in the third area may have a third diameter smaller than the second diameter.

In the radar device according to an aspect of the present disclosure, the electromagnetic wave may have a frequency of 76 to 77 GHz.

According to another aspect of the present disclosure, provided is a radar device that generates and transmits electromagnetic waves and receive electromagnetic waves that are reflected and returned from the outside, the radar device including a plate-shaped first waveguide in which a first port through which the electromagnetic waves pass is through-formed; a second waveguide that is stacked on one surface of the first waveguide, and in which a second port through which the electromagnetic waves pass is through-formed, the second port being in communication with the first port; and a plurality of pins having a polygonal pillar shape, the plurality of pins being disposed to be spaced apart from each other, in a form surrounding an opening of the first port, on one surface of the first waveguide facing the second waveguide, or disposed to be spaced apart from each other, in a form surrounding an opening of the second port, on one surface of the second waveguide facing the first waveguide.

In the radar device according to another aspect of the present disclosure, each of the plurality of pins may have a hexagonal pillar shape.

In the radar device according to another aspect of the present disclosure, each of the plurality of pins may be arranged such that a normal line of an opposite side facing the opening surrounded by the plurality of pins is perpendicular to an edge of the opening surrounded by the plurality of pins or a tangent line of the edge.

In the radar device according to another aspect of the present disclosure, a distance between the plurality of pins may be formed to be constant.

In the radar device according to another aspect of the present disclosure, some of the plurality of pins may have a first diameter, and another some of the plurality of pins may have a second diameter smaller than the first diameter.

In the radar device according to another aspect of the present disclosure, some of the plurality of pins may be placed in a first area within a first distance from an edge of the opening surrounded by the plurality of pins, and another some of the plurality of pins may be placed in a second area that is farther than the first distance and within a second distance from the edge of the opening surrounded by the plurality of pins (the second distance is greater than the first distance).

In the radar device according to another aspect of the present disclosure, among the plurality of pins, those disposed in the first area may have a first diameter, and among the plurality of pins, those disposed in the second area may have a second diameter smaller than the first diameter.

In the radar device according to another aspect of the present disclosure, yet another some of the plurality of pins may be placed in a third area that is farther than the second distance and within a third distance from the edge of the opening surrounded by the pins (the third distance is greater than the second distance).

In the radar device according to another aspect of the present disclosure, among the plurality of pins, those disposed in the third area may have a third diameter smaller than the second diameter.

### BRIEF DESCRIPTION OF THE SEVERAL VIEWS OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a diagram illustrating a configuration of a radar device according to an exemplary embodiment of the present disclosure;

FIG. 2 is a diagram illustrating a case in which an orientation of a circuit board is changed in a radar device according to an exemplary embodiment of the present disclosure;

FIG. 3 is a view illustrating a pin of a radar device according to an exemplary embodiment of the present disclosure;

FIG. 4 is a perspective view illustrating arrangement of a plurality of pins of a radar device according to an exemplary embodiment of the present disclosure.

FIG. 5 is a plan view of arrangement of a plurality of pins of a radar device according to an exemplary embodiment of the present disclosure.

FIG. 6 is a graph illustrating insertion loss when a plurality of pins of a radar device according to an exemplary embodiment of the present disclosure are arranged as shown in FIGS. 4 and 5;

FIG. 7 is a graph illustrating reflection loss when a plurality of pins of a radar device according to an exemplary embodiment of the present disclosure are arranged as shown in FIGS. 4 and 5;

FIG. 8 is a plan view of another example of arrangement of a plurality of pins of a radar device according to an exemplary embodiment of the present disclosure;

FIG. 9 is a graph illustrating insertion loss when a plurality of pins of a radar device according to an exemplary embodiment of the present disclosure are arranged as shown in FIG. 8;

FIG. 10 is a graph illustrating reflection loss when a plurality of pins of a radar device according to an exemplary embodiment of the present disclosure are arranged as shown in FIG. 8;

FIG. 11 is a plan view of yet another example of arrangement of a plurality of pins of a radar device according to an exemplary embodiment of the present disclosure;

FIG. 12 is a graph illustrating insertion loss according to manufacturing tolerance when a plurality of pins of a radar device according to an exemplary embodiment of the present disclosure are arranged as shown in FIG. 11;

FIG. 13 is a graph illustrating insertion loss according to manufacturing tolerance when a plurality of pins of a radar device according to an exemplary embodiment of the present disclosure are arranged as shown in FIGS. 4 and 5; and

FIG. 14 is a diagram illustrating a configuration of a radar device according to another exemplary embodiment of the present disclosure.

### DETAILED DESCRIPTION

Hereinafter, embodiments of the present disclosure will be described in detail so that those skilled in the art to which the present disclosure pertains can easily carry out the embodiments. The present disclosure may be implemented in many different forms and is not limited to the embodiments described herein. In order to clearly describe the present disclosure, portions not related to the description are omitted from the accompanying drawings, and the same or similar components are denoted by the same reference numerals throughout the specification.

The words and terms used in the specification and the claims are not limitedly construed as their ordinary or dictionary meanings, and should be construed as meaning and concept consistent with the technical spirit of the present disclosure in accordance with the principle that the inventors can define terms and concepts in order to best describe their disclosure.

In the specification, it should be understood that the terms such as “comprise” or “have” are intended to specify the presence of features, numbers, steps, operations, components, parts, or combinations thereof described in the specification and do not preclude the possibility of the presence or addition of one or more other features, numbers, steps, operations, components, parts, or combinations thereof.

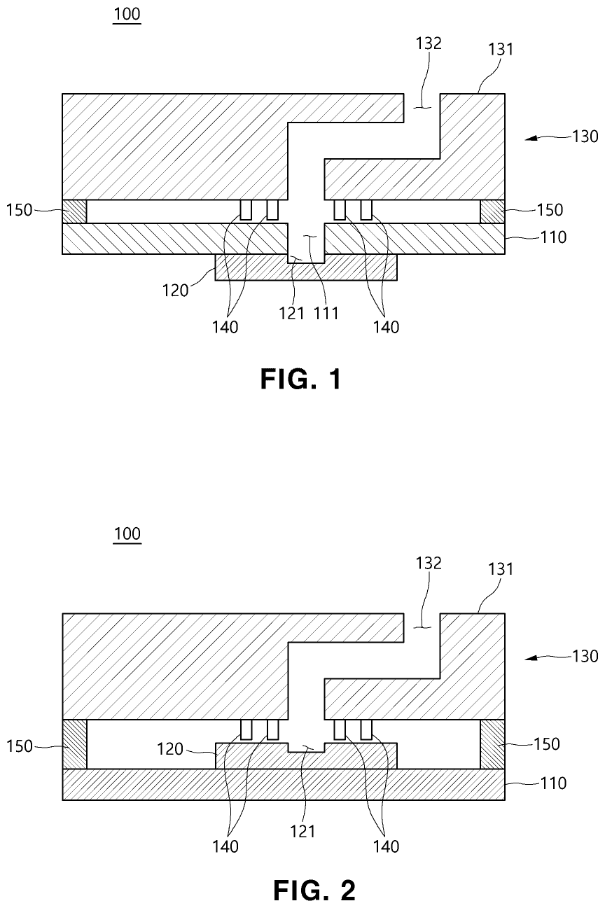

FIG. 1 is a diagram illustrating a configuration of a radar device according to an exemplary embodiment of the present disclosure.

FIG. 1 is for showing the arrangement of components of the radar device 100 according to an exemplary embodiment of the present disclosure, and a relative difference in size or volume of the components is not considered.

The radar device 100 according to an exemplary embodiment of the present disclosure detects an object by transmitting electromagnetic waves and receiving electromagnetic waves reflected and returned from an object existing outside. For example, the radar device 100 according to an exemplary embodiment of the present disclosure may be mounted on a vehicle and used to detect objects around the vehicle. More specifically, the radar device 100 according to an exemplary embodiment of the present disclosure may radiate electromagnetic waves to determine the distance to various targets around the vehicle, the speed of the target, the angle of the target, and the like, and receive electromagnetic waves reflected and returned from the target.

Of course, the use of the radar device 100 according to an exemplary embodiment of the present disclosure is not limited to vehicle use. The radar device 100 according to an exemplary embodiment of the present disclosure may be used in various fields requiring detection of an object through electromagnetic waves.

Referring to FIG. 1, the radar device 100 according to an exemplary embodiment of the present disclosure may include a circuit board 110, a circuit element 120, a waveguide antenna 130, and a plurality of pins 140.

The circuit element 120 for generating or receiving electromagnetic waves is disposed on the circuit board 110. The circuit board 110 may be implemented as a printed circuit board (PCB).

The circuit element 120 generates or receives electromagnetic waves. The circuit element 120 may be mounted on the circuit board 110. In an embodiment of the present disclosure, the circuit element 120 may be a monolithic microwave integrated circuit (MMIC). MMIC refers to an ultra-small ultra-high frequency integrated circuit in which passive elements such as resistors, inductors, and capacitors and active elements such as transistors and FETs are manufactured on a single semiconductor circuit board in a collective process.

The circuit board 110 and the circuit element 120 may be configured in the form of a launcher in package (LiP) that directly transmits an electromagnetic wave signal from the circuit element 120 to the waveguide antenna 130.

Alternatively, the radar device 100 according to an exemplary embodiment of the present disclosure may further include a launcher on board (LoB) (not shown) for transmitting electromagnetic waves generated from the circuit element 120 to the waveguide antenna 130. In this case, electromagnetic waves generated from the circuit element 120 may be transferred to the waveguide antenna 130 through LoB.

The LiP or LoB method may minimize fluctuations in radar performance due to losses related to dielectric constant of the circuit board 110.

The frequency of the electromagnetic wave generated by the circuit element 120 may be 76 to 81 GHz. In more detail, the frequency of the electromagnetic wave generated by the circuit element 120 may be 76 to 77 GHz (for example, 76.5 GHZ). This frequency range is suitable for a vehicle radar that is placed in a vehicle and detect objects around the vehicle.

When the frequency of the electromagnetic wave is formed as above, the wavelength of the electromagnetic wave may be 3 to 5 mm (for example, about 4 mm).

The waveguide antenna 130 is stacked and disposed on one surface of the circuit board 110, and a port 132 through which the electromagnetic wave passes is formed therethrough. The waveguide antenna 130 may have a block or plate shape. For example, the waveguide antenna 130 may have a rectangular block shape or a rectangular plate shape.

The waveguide antenna 130 may include a waveguide antenna body 131 and a port 132 passing through the waveguide antenna body 131.

The waveguide antenna body 131 may have a block or plate shape. In more detail, the waveguide antenna body 131 may have a rectangular block shape or a rectangular plate shape. The waveguide antenna body 131 is stacked and disposed on one surface of the circuit board 110. In addition, the other surface of the waveguide antenna body 131 may be disposed facing the outside.

The port 132 may pass through one surface and the other surface of the waveguide antenna body 131. The port 132 provides a transmission path of electromagnetic waves so that the electromagnetic waves generated by the circuit element 120 may be transmitted to the outside. In addition, electromagnetic waves reflected and returned from an external object may pass through port 132 and be transmitted to circuit element 120.

Referring to FIG. 1, the waveguide antenna 130 is stacked on one surface of the circuit board 110, and the circuit element 120 is disposed on the other surface of the circuit board 110. In addition, the circuit element 120 includes an oscillator 121 for oscillating electromagnetic waves.

In this regard, the circuit board 110 may include a through hole 111 formed through which electromagnetic waves can be transmitted from the circuit element 120 to the waveguide antenna 130 or from the waveguide antenna 130 to the circuit element 120. In this case, the through hole 111 may be disposed in communication with the oscillator 121 of the circuit element 120.

The waveguide antenna 130 may be arranged such that the port 132 and the through hole 111 are aligned. Accordingly, the oscillator 121 of the circuit element 120, the through hole 111, and the port 132 may be in communication with each other to form a transmission path of electromagnetic waves.

Meanwhile, when viewed in a plan view, the port 132 may have a shape that may overlap the opening of the port 132 in a state in which it is arranged aligned with the through hole 111. In other words, the opening of the port 132 of the waveguide antenna 130 and the through hole 111 may have the same shape.

In addition, one or more support members 150 may be disposed between the circuit board 110 and the waveguide antenna 130. The support member 150 provides a mechanical support structure between the circuit board 110 and the waveguide antenna 130.

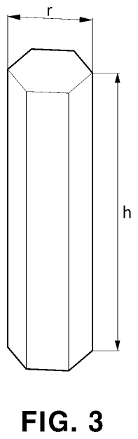

FIG. 2 is a diagram illustrating a case in which an orientation of a circuit board is changed in a radar device according to an exemplary embodiment of the present disclosure.

Referring to FIG. 2, the circuit element 120 may be disposed on one surface of the circuit board 110, and the waveguide antenna 130 may also be stacked on one surface of the circuit board 110. In this case, the waveguide antenna 130 may be arranged such that the port 132 is aligned with the oscillator 121 of the circuit element 120. Accordingly, the oscillator 121 of the circuit element 120 and the port 132 may be in communication with each other to form a transmission path of electromagnetic waves.

In this case, one or more support members 150 may be disposed between the circuit board 110 and the waveguide antenna 130. The support member 150 provides a mechanical support structure between the circuit board 110 and the waveguide antenna 130.

A plurality of pins 140 are disposed to be spaced apart from each other in a form surrounding the opening of the port 132 on one surface of the waveguide antenna 130 facing the circuit board 110. The plurality of pins 140 have a pillar shape. For example, the plurality of pins 140 may have a polygonal pillar shape.

FIG. 3 is a view illustrating a pin of a radar device according to an exemplary embodiment of the present disclosure.

Referring to FIG. 3, the pin 140 has a hexagonal pillar shape. In more detail, the transverse section of the pin 140 may be formed in a regular hexagon.

For example, the diameter r of the pin 140 may be 0.2 to 1.2 mm and the height h may be 0.5 to 1.5 mm. When the pin 140 has a polygonal pillar shape, the diameter r of the pin 140 may be defined as the circumferential diameter of the transverse section of the pin 140.

The plurality of pins 140 may be integrally formed with the waveguide antenna 130. In other words, the plurality of pins 140 may be formed together on one surface of the waveguide antenna 130 when forming the waveguide antenna 130.

When the waveguide antenna 130 is stacked and disposed on one surface of the circuit board 110, a gap may be formed between the circuit board 110 and the waveguide antenna 130 or between the circuit element 120 and the waveguide antenna 130. In particular, when the circuit board 110 and the circuit element 120 are configured in a LiP or LoB method, fluctuations in radar performance due to losses related to the dielectric constant of the circuit board 110 may be minimized, while a minute gap between the feeding part of the electromagnetic wave and the waveguide antenna 130 may be caused.

When electromagnetic waves travel from the circuit board 110 or the circuit element 120 to the port 132 of the waveguide antenna 130, or when electromagnetic waves travel from the port 132 of the waveguide antenna 130 to the circuit board 110 or the circuit element 120, leakage of electromagnetic waves may occur through such a gap.

In this regard, it is known that leakage of electromagnetic waves easily occurs through fine gaps when electromagnetic waves have wavelengths in the millimeter band, resulting in a decrease in radar performance such as reduction of detecting distance and false detecting.

The plurality of pins 140 are disposed to be spaced apart from each other in a form surrounding the opening of the port 132 on one surface of the waveguide antenna 130 facing the circuit board 110, thereby suppressing leakage of electromagnetic waves through the gap between the circuit board 110 and the waveguide antenna 130 or between the circuit element 120 and the waveguide antenna 130. In other words, the plurality of pins 140 may provide an artificial magnetic conductor (AMC) structure.

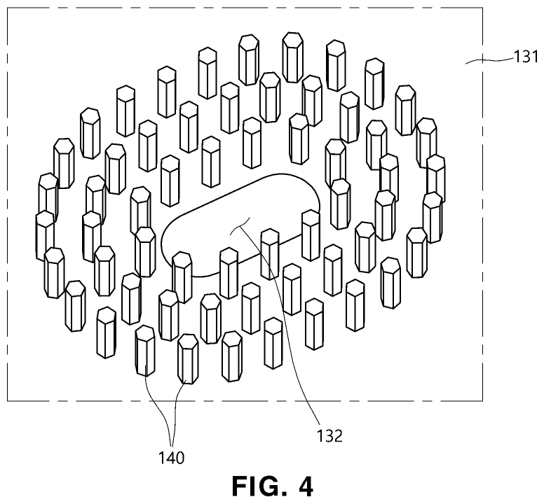

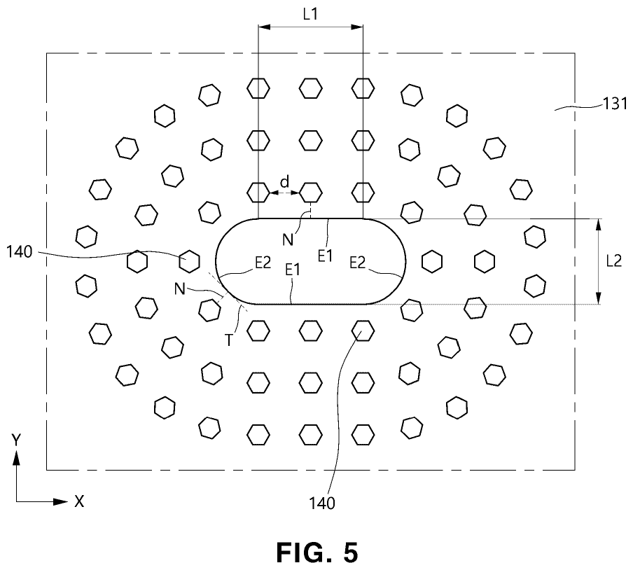

FIG. 4 is a perspective view illustrating arrangement of a plurality of pins of a radar device according to an exemplary embodiment of the present disclosure. In addition, FIG. 5 is a plan view of arrangement of a plurality of pins of a radar device according to an exemplary embodiment of the present disclosure.

Referring to FIGS. 4 and 5, each of the plurality of pins 140 may be arranged such that the normal line N of the opposite side facing the opening of the port 132 is perpendicular to the edge of the opening or the tangent line T of the edge of the opening. As such, a structure in which the normal line N of the opposite side of each of the plurality of pins 140 is arranged to be perpendicular to the edge of the opening or the tangent line T of the edge of the opening may be defined as an adaptive arrangement structure.

The opening of the port 132 may have a slot hole shape. In more detail, the opening of the port 132 may include a rectangular central portion extending with a predetermined width and arc-shaped ends respectively connected to both ends of the central portion in the longitudinal direction (X-axis direction). Accordingly, the edge of the opening of the port 132 may include straight sections E1 and arc-shaped sections E2 of both ends in the longitudinal direction in the central portion.

In an embodiment of the present disclosure, among the plurality of pins 140, those having opposite sides facing the straight section E1 of the edge of the opening of the port 132 may be arranged such that the normal line N of the opposite side is perpendicular to the straight section E1 of the edge of the opening of the port 132. In addition, among the plurality of pins 140, those having opposite sides facing the arc-shaped section E2 of the edge of the opening of the port 132 may be arranged such that the normal line N of the opposite side is perpendicular to the tangent line T passing through one point of the arc-shaped section E2 of the edge of the opening of the port 132.

In order to adaptively arrange the plurality of pins 140 as described above, it is advantageous for the pins 140 to have a polygonal pillar shape. In more detail, when the pin 140 has a hexagonal pillar shape, an adaptive arrangement structure may be easily formed.

The distance d between the plurality of pins 140 may be formed to be constant. For example, when the opening of the port 132 has a slot hole shape, the edge of the opening of the port 132 includes straight sections E1 and arc-shaped sections E2 of both ends in the longitudinal direction in the central portion, the length L1 of the straight section E1 is 1.4 mm, and the arc-shaped section E2 has a semicircular shape and the diameter L2 is 1.15 mm, the distance d between the plurality of pins 140 may be formed with a value selected from 0.6 to 0.8 mm (e.g., 0.7 mm).

As a result of the simulation, it was confirmed that 3.6% of power leakage occurred between the waveguide antenna 130 and the circuit board 110 when the frequency of the electromagnetic wave is 77 GHz, a plurality of pins 140 of the radar device 100 according to an exemplary embodiment of the present disclosure are arranged as shown in FIGS. 4 and 5, and a 0.2 mm gap exists between the circuit board 110 and the plurality of pins 140.

Meanwhile, it was confirmed that 13.3% of power leakage occurred between the waveguide antenna 130 and the circuit board 110 when the frequency of the electromagnetic wave is 77 GHz, a 0.2 mm gap exists between the circuit board 110 and the waveguide antenna 130, and a plurality of pins 140 are not arranged.

As can be seen from this, the radar device 100 according to an exemplary embodiment of the present disclosure reduces the loss of electromagnetic waves in the gap between the circuit board 110 and the waveguide antenna 130 by the plurality of pins 140.

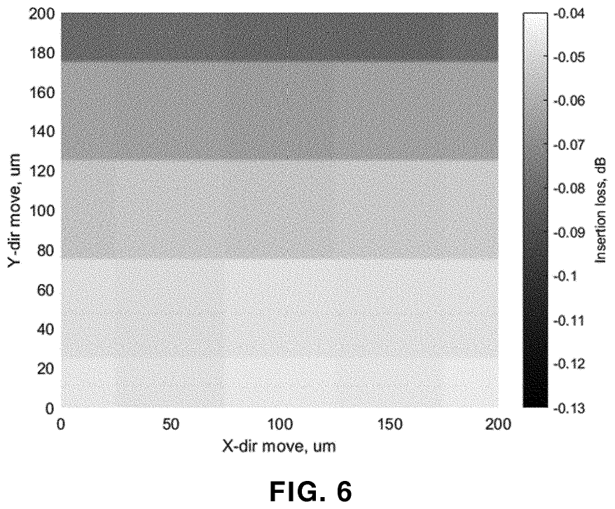

FIG. 6 is a graph illustrating insertion loss when a plurality of pins of a radar device according to an exemplary embodiment of the present disclosure are arranged as shown in FIGS. 4 and 5.

FIG. 6 shows insertion loss according to the distance misaligned (X-dir move) on the X-axis or the distance misaligned (Y-dir move) on the Y-axis of the opening of the port 132 and the through hole 111 of the circuit board 110 based on the state in which the opening of the port 132 and the through hole 111 of the circuit board 110 are arranged so as to completely overlap each other when viewed in a plan view. The unit of distance is micrometers (μm).

In FIG. 6, the maximum value of power delivery is shown as 0.99, and the minimum value of power delivery is shown as 0.98. This means that insertion loss hardly occurs, and that the radar device 100 according to an exemplary embodiment of the present disclosure has a characteristic that is robust to misalignment between the opening of the port 132 and the through hole 111.

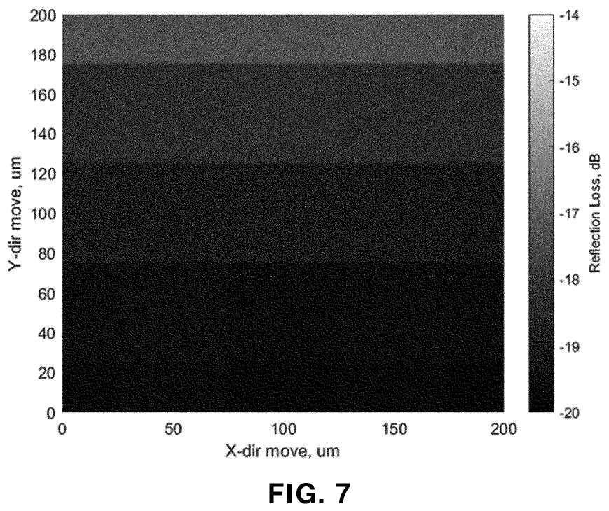

In addition, FIG. 7 is a graph illustrating reflection loss when a plurality of pins of a radar device according to an exemplary embodiment of the present disclosure are arranged as shown in FIGS. 4 and 5.

FIG. 7 shows reflection loss according to the distance misaligned (X-dir move) on the X-axis or the distance misaligned (Y-dir move) on the Y-axis of the opening of the port 132 and the through hole 111 of the circuit board 110 based on the state in which the opening of the port 132 and the through hole 111 of the circuit board 110 are arranged so as to completely overlap each other when viewed in a plan view.

Referring to FIG. 7, the maximum reflectance is shown as 0.02 and the minimum reflectance is shown as 0.01. This means that reflection loss hardly occurs, and that the radar device 100 according to an exemplary embodiment of the present disclosure has a characteristic that is robust to misalignment between the opening of the port 132 and the through hole 111.

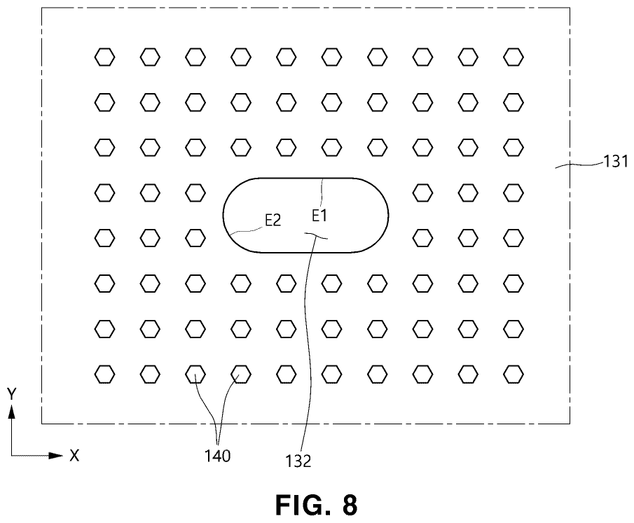

FIG. 8 is a plan view of another example of arrangement of a plurality of pins of a radar device according to an exemplary embodiment of the present disclosure.

Referring to FIG. 8, a plurality of pins 140 do not have an adaptive arrangement structure and are arranged with the same orientation while surrounding the opening of the port 132 in a grid shape. In more detail, among the plurality of pins 140, those having opposite sides facing the straight section E1 of the edge of the opening of the port 132 are arranged such that the normal line of the opposite side is perpendicular to the straight section E1 of the edge of the opening of the port 132, but among the plurality of pins 140, those having opposite sides facing the arc-shaped section E2 of the edge of the opening of the port 132 are not arranged such that the normal line of the opposite side is perpendicular to the tangent line passing through one point of the arc-shaped section E2 of the edge of the opening of the port 132, but are all arranged with the same orientation.

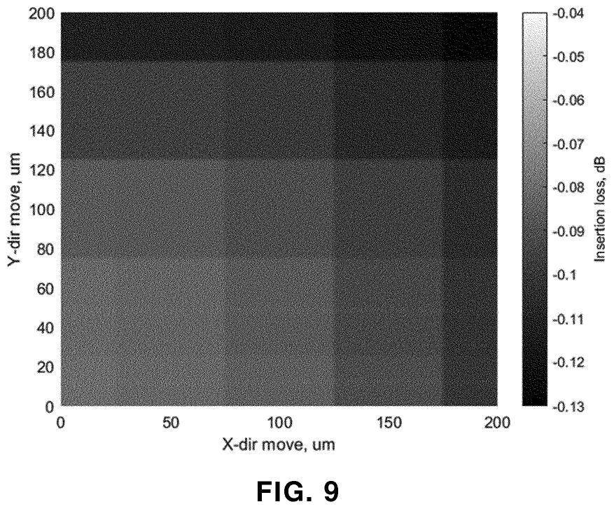

FIG. 9 is a graph illustrating insertion loss when a plurality of pins of a radar device according to an exemplary embodiment of the present disclosure are arranged as shown in FIG. 8.

FIG. 9 shows insertion loss according to the distance misaligned (X-dir move) on the X-axis or the distance misaligned (Y-dir move) on the Y-axis of the opening of the port 132 and the through hole 111 of the circuit board 110 based on the state in which the opening of the port 132 and the through hole 111 of the circuit board 110 are arranged so as to completely overlap each other when viewed in a plan view. The unit of distance is micrometers (μm).

Referring to FIG. 9, the maximum value of power delivery is shown as 0.98, and the minimum value of power delivery is shown as 0.97. These numerical values also show that the radar device 100 according to an exemplary embodiment of the present disclosure has a characteristic that is robust to misalignment between the opening of the port 132 and the through hole 111.

However, when comparing FIG. 9 with FIG. 6, FIG. 6 appears relatively bright over the entire area and shows slightly better performance in terms of insertion loss. This means that the electromagnetic wave leakage suppression performance increases when a plurality of pins 140 are adaptively arranged.

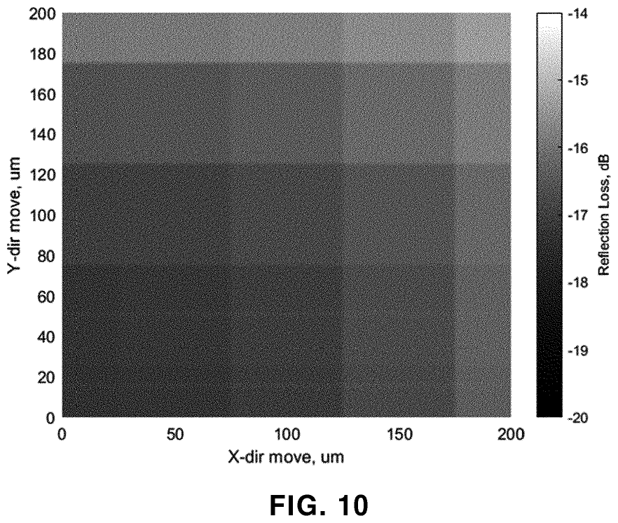

FIG. 10 is a graph illustrating reflection loss when a plurality of pins of a radar device according to an exemplary embodiment of the present disclosure are arranged as shown in FIG. 8.

FIG. 10 shows reflection loss according to the distance misaligned (X-dir move) on the X-axis or the distance misaligned (Y-dir move) on the Y-axis of the opening of the port 132 and the through hole 111 of the circuit board 110 based on the state in which the opening of the port 132 and the through hole 111 of the circuit board 110 are arranged so as to completely overlap each other when viewed in a plan view.

Referring to FIG. 10, the maximum reflectance is shown as 0.03 and the minimum reflectance is shown as 0.02. These numerical values also show that the radar device 100 according to an exemplary embodiment of the present disclosure has a characteristic that is robust to misalignment between the opening of the port 132 and the through hole 111.

However, when comparing FIG. 10 with FIG. 7, FIG. 7 appears relatively dark over the entire area and shows slightly better performance in terms of reflection loss. This means that the electromagnetic wave leakage suppression performance increases when a plurality of pins 140 are adaptively arranged.

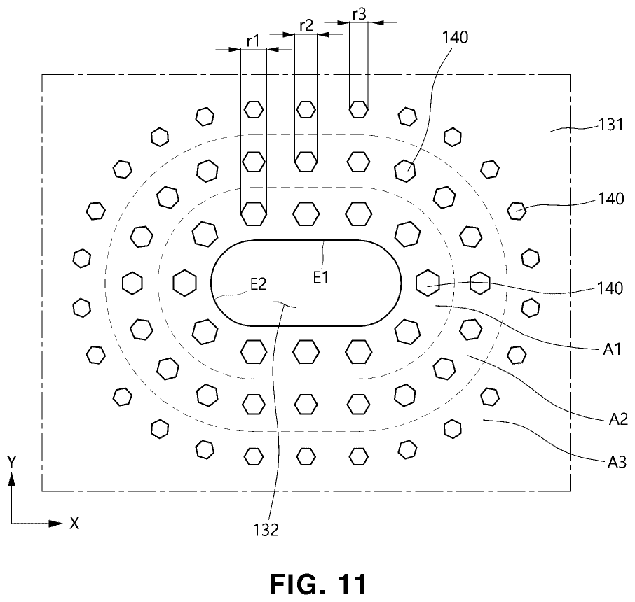

FIG. 11 is a plan view of yet another example of arrangement of a plurality of pins of a radar device according to an exemplary embodiment of the present disclosure.

Referring to FIG. 11, some of the plurality of pins 140 may have a first diameter r1, and another some of the plurality of pins 140 may have a second diameter r2 smaller than the first diameter r1.

In addition, some of the plurality of pins 140 may be placed in a first area A1 within a first distance from the edge of the opening of the port 132, and another some of the plurality of pins 140 may be placed in a second area A2 that is farther than the first distance and within a second distance from the edge of the opening of the port 132 (the second distance is greater than the first distance).

In this case, among the plurality of pins 140, those disposed in the first area A1 may have the first diameter r1, and among the plurality of pins 140, those disposed in the second area A2 may have the second diameter r2 smaller than the first diameter r1.

In addition, yet another some of the plurality of pins 140 may be placed in a third area A3 that is farther than the second distance and within a third distance from the edge of the opening of the port 132 (the third distance is greater than the second distance).

In this case, among the plurality of pins 140, those disposed in the third area A3 may have a third diameter r3 smaller than the second diameter r2.

As shown in FIG. 11, a structure in which a plurality of pins 140 are disposed may be defined as a pin size differential adaptive structure.

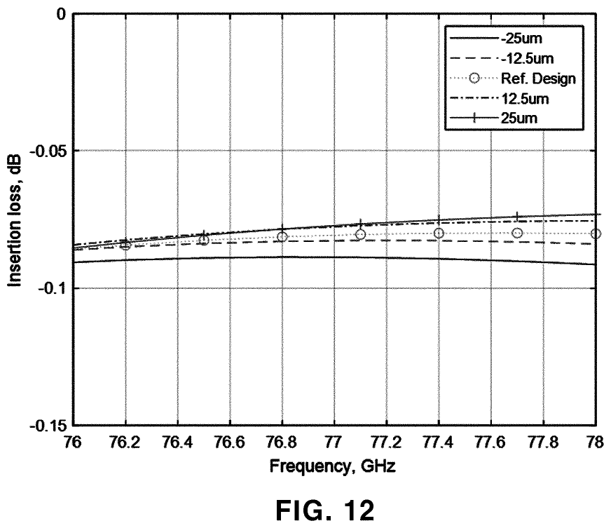

FIG. 12 is a graph illustrating insertion loss according to manufacturing tolerance when a plurality of pins of a radar device according to an exemplary embodiment of the present disclosure are arranged as shown in FIG. 11.

In more detail, FIG. 12 shows insertion loss (dB) according to frequency (GHz) of electromagnetic waves when each pin 140 has a manufacturing tolerance of ±12.5 μm or ±25 μm based on the design dimension (Ref. Design) when a plurality of pins 140 are arranged in the pin size differential adaptive structure as shown in FIG. 11 in the radar device 100 according to an exemplary embodiment of the present disclosure.

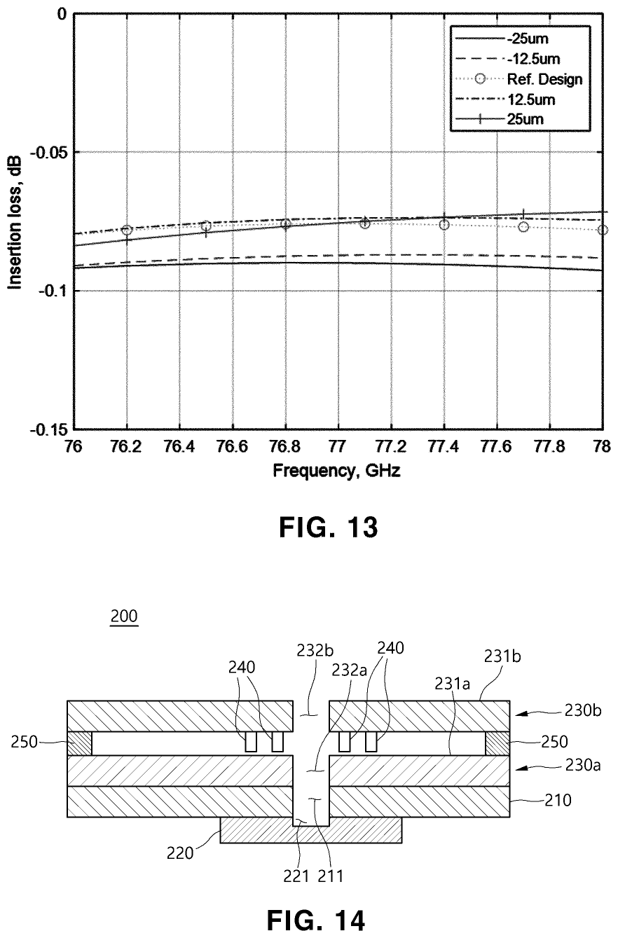

FIG. 13 is a graph illustrating insertion loss according to manufacturing tolerance when a plurality of pins of a radar device according to an exemplary embodiment of the present disclosure are arranged as shown in FIGS. 4 and 5.

In more detail, FIG. 13 shows insertion loss (dB) according to frequency (GHz) of electromagnetic waves when each pin 140 has a manufacturing tolerance of ±12.5 μm or ±25 μm based on the design dimension (Ref. Design) when a plurality of pins 140 are arranged as shown in FIGS. 4 and 5 in the radar device 100 according to an exemplary embodiment of the present disclosure.

Comparing FIGS. 12 and 13, it can be seen that when a plurality of pins 140 are arranged in the pin size differential adaptive structure, a characteristic that is relatively more robust to manufacturing tolerances is exhibited. In particular, when the frequency of electromagnetic wave is in the 76 to 77 GHz band, the robust characteristics of the pin size differential adaptive structure are greatly exhibited, and the 76 to 77 GHz band is a suitable frequency band for vehicle radar. This means that when a plurality of pins 140 are arranged in the pin size differential adaptive structure, the radar device 100 according to an exemplary embodiment of the present disclosure can provide a more advantageous effect when used for a vehicle.

FIG. 14 is a diagram illustrating a configuration of a radar device according to another exemplary embodiment of the present disclosure.

FIG. 14 is for showing the arrangement of components of the radar device 200 according to another exemplary embodiment of the present disclosure, and a relative difference in size or volume of the components is not considered.

The radar device 200 according to another exemplary embodiment of the present disclosure transmits electromagnetic waves and receives electromagnetic waves reflected and returned from the outside. For example, the radar device 200 according to another exemplary embodiment of the present disclosure may be mounted on a vehicle and used to detect objects around the vehicle. Of course, the use of the radar device 200 according to another exemplary embodiment of the present disclosure is not limited to vehicle use.

Referring to FIG. 14, the radar device 200 according to another exemplary embodiment of the present disclosure may include a circuit board 210, a circuit element 220, a first waveguide 230a, a second waveguide 230b, and a plurality of pins 240.

The circuit element 220 for generating or receiving electromagnetic waves is disposed on the circuit board 210. The circuit board 210 may be implemented as a printed circuit board (PCB).

The circuit element 220 generates or receives electromagnetic waves. The circuit clement 220 may be mounted on the circuit board 210. In an embodiment of the present disclosure, the circuit element 220 may be a monolithic microwave integrated circuit (MMIC). The frequency of the electromagnetic wave generated by the circuit element 220 may be 76 to 81 GHZ.

The first waveguide 230a is stacked on one surface of the circuit board 210, and the circuit element 220 is disposed on the other surface of the circuit board 210. In addition, the circuit element 220 includes an oscillator 221 for oscillating electromagnetic waves.

The circuit board 210 may include a through hole 211 formed through which electromagnetic waves can be transmitted from the circuit element 220 to the first waveguide 230a or from the first waveguide 230a to the circuit clement 220. In this case, the through hole 211 may be disposed in communication with the oscillator 121 of the circuit element 120.

Meanwhile, both the circuit element 220 and the first waveguide 230a examined in connection with FIG. 2 may be disposed on one surface of the circuit board 210. In this case, the circuit board 210 may not include the through hole 211.

The first waveguide 230a provides a transmission path of electromagnetic waves between the circuit element 220 and the outside. A first port 232a through which electromagnetic waves pass is through-formed in the first waveguide 230a. The first waveguide 230a may have a plate shape.

In more detail, the first waveguide 230a may include a plate-shaped first waveguide body 231a and a first port 232a penetrating the first waveguide body 231a. The first waveguide body 231a is stacked and disposed on one surface of the circuit board 210. The first port 232a may penetrate one surface and the other surface of the first waveguide body 231a.

The second waveguide 230b provides a transmission path of electromagnetic waves between the first waveguide 230a and the outside. A second port 232b disposed in communication with the first port 232a to allow electromagnetic waves to pass through the second port 232b is through-formed in the second waveguide 230b. The second waveguide 230b may be stacked and disposed on one surface of the first waveguide 230a. In addition, the second waveguide 230b may have a plate shape.

In more detail, the second waveguide 230b may include a plate-shaped second waveguide body 231b and a second port 232b penetrating the second waveguide body 231b. The second waveguide body 231b is stacked and disposed on one surface of the first waveguide 230a. The second port 232b may penetrate one surface and the other surface of the second waveguide body 231b.

In addition, one or more support members 250 may be disposed between the first waveguide 230a and the second waveguide 230b. The support member 250 provides a mechanical support structure between the first waveguide 230a and the second waveguide 230b.

The plurality of pins 240 are disposed to be spaced apart from each other in a form surrounding the opening of the first port 232a on one surface of the first waveguide 230a facing the second waveguide 230b, or are disposed to be spaced apart from each other in a form surrounding the opening of the second port 232b on one surface of the second waveguide 230b facing the first waveguide 230a.

The plurality of pins 240 suppress leakage of electromagnetic waves in the gap between the first waveguide 230a and the second waveguide 230b. In other words, the plurality of pins 240 may provide an artificial magnetic conductor (AMC) structure.

The plurality of pins 240 may have a polygonal pillar shape. For example, the plurality of pins 240 may have a hexagonal pillar shape.

The plurality of pins 240 may be integrally molded with the first waveguide 230a or the second waveguide 230b.

Each of the plurality of pins 240 may be arranged such that a normal line of an opposite side facing an opening surrounded by the plurality of pins 240 is perpendicular to an edge of the opening surrounded by the plurality of pins 240 or a tangent line to the edge. That is, as described in connection with an exemplary embodiment of the present disclosure, the plurality of pins 240 may have an adaptive arrangement structure.

In addition, the distance between the plurality of pins 240 may be formed to be constant.

Some of the plurality of pins 240 may have a first diameter, and another some of the plurality of pins 240 may have a second diameter smaller than the first diameter. Some of the plurality of pins 240 may be placed in a first area within a first distance from the edge of the opening surrounded by the plurality of pins 240, and another some of the plurality of pins 240 may be placed in a second area that is farther than the first distance and within a second distance from the edge of the opening surrounded by the plurality of pins 240 (the second distance is greater than the first distance).

In this case, among the plurality of pins 240, those disposed in the first area may have a first diameter, and among the plurality of pins 240, those disposed in the second area may have a second diameter smaller than the first diameter.

In addition, yet another some of the plurality of pins 240 may be placed in a third area that is farther than the second distance and within a third distance from the edge of the opening surrounded by the plurality of pins 240 (the third distance is greater than the second distance). In this case, among the plurality of pins 240, those disposed in the third area may have a third diameter smaller than the second diameter.

In other words, as described in connection with an exemplary embodiment of the present disclosure, the plurality of pins 240 may have a pin size differential adaptive structure.

According to the above configuration, the radar device according to an aspect of the present disclosure effectively suppresses leakage during the transmission process of electromagnetic waves through a plurality of pins placed around the opening of the port through which electromagnetic waves pass.

In addition, the radar device according to an aspect of the present disclosure provides robustness against fine gaps or axis alignment defects that can occur between layers when constructing a waveguide feeding line of electromagnetic waves in the form of a plurality of pins placed around the opening of the port through which electromagnetic waves pass.

It should be understood that the effects of the present disclosure are not limited to the above-described effects, and include all effects inferable from a configuration of the invention described in detailed descriptions or claims of the present disclosure.

Although embodiments of the present disclosure have been described, the spirit of the present disclosure is not limited by the embodiments presented in the specification. Those skilled in the art who understand the spirit of the present disclosure will be able to easily suggest other embodiments by adding. changing, deleting, or adding components within the scope of the same spirit, but this will also be included within the scope of the spirit of the present disclosure.

1. A radar device, comprising:
a circuit board on which a circuit element that generates or receives electromagnetic waves is placed;
a waveguide antenna stacked on one surface of the circuit board, and in which a port through which the electromagnetic waves pass is through-formed; and
a plurality of pins spaced apart from each other, in the form of surrounding an opening of the port, on one surface of the waveguide antenna facing the circuit board, and having a pillar shape.

2. The radar device of claim 1, wherein each of the plurality of pins has a polygonal pillar shape.

3. The radar device of claim 2, wherein each of the plurality of pins has a hexagonal pillar shape.

4. The radar device of claim 2, wherein each of the plurality of pins is arranged such that a normal line of an opposite side facing the opening is perpendicular to an edge of the opening or a tangent line of the edge of the opening.

5. The radar device of claim 1, wherein a distance between the plurality of pins is formed to be constant.

6. The radar device of claim 1, wherein some of the plurality of pins have a first diameter, and another some of the plurality of pins have a second diameter smaller than the first diameter.

7. The radar device of claim 1, wherein some of the plurality of pins are placed in a first area within a first distance from an edge of the opening of the port, and another some of the plurality of pins are placed in a second area that is farther than the first distance and within a second distance from the edge of the opening of the port, and
wherein the second distance is greater than the first distance.

8. The radar device of claim 7, wherein among the plurality of pins, those disposed in the first area have a first diameter, and among the plurality of pins, those disposed in the second area have a second diameter smaller than the first diameter.

9. The radar device of claim 8, wherein yet another some of the plurality of pins are placed in a third area that is farther than the second distance and within a third distance from the edge of the opening of the port, and
wherein the third distance is greater than the second distance.

10. The radar device of claim 9, wherein among the plurality of pins, those disposed in the third area have a third diameter smaller than the second diameter.

11. A radar device that generates and transmits electromagnetic waves and receive electromagnetic waves that are reflected and returned from the outside, the radar device comprising:
a plate-shaped first waveguide in which a first port through which the electromagnetic waves pass is through-formed;
a second waveguide that is stacked on one surface of the first waveguide, and in which a second port through which the electromagnetic waves pass is through-formed, the second port being in communication with the first port; and
a plurality of pins having a polygonal pillar shape, the plurality of pins being disposed to be spaced apart from each other, in a form surrounding an opening of the first port, on one surface of the first waveguide facing the second waveguide, or disposed to be spaced apart from each other, in a form surrounding an opening of the second port, on one surface of the second waveguide facing the first waveguide.

12. The radar device of claim 11, wherein each of the plurality of pins has a hexagonal pillar shape.

13. The radar device of claim 11, wherein each of the plurality of pins is arranged such that a normal line of an opposite side facing the opening surrounded by the plurality of pins is perpendicular to an edge of the opening surrounded by the plurality of pins or a tangent line of the edge.

14. The radar device of claim 11, wherein a distance between the plurality of pins is formed to be constant.

15. The radar device of claim 11, wherein some of the plurality of pins have a first diameter, and another some of the plurality of pins have a second diameter smaller than the first diameter.

16. The radar device of claim 11, wherein some of the plurality of pins are placed in a first area within a first distance from an edge of the opening surrounded by the plurality of pins, and another some of the plurality of pins are placed in a second area that is farther than the first distance and within a second distance from the edge of the opening surrounded by the plurality of pins, and
wherein the second distance is greater than the first distance.

17. The radar device of claim 16, wherein among the plurality of pins, those disposed in the first area have a first diameter, and among the plurality of pins, those disposed in the second area have a second diameter smaller than the first diameter.

18. The radar device of claim 17, wherein yet another some of the plurality of pins are placed in a third area that is farther than the second distance and within a third distance from the edge of the opening surrounded by the pins, and
wherein the third distance is greater than the second distance.

19. The radar device of claim 18, wherein among the plurality of pins, those disposed in the third area have a third diameter smaller than the second diameter.
